(19) United States
(12) Patent Application Publication
(10) Pub. No.: US 2004/0157245 A1
(43) Pub. Date: Aug. 12, 2004

(54) Separation device for processing biomolecules

(76) Inventors: Edmund Radmacher, Duren (DE); Klaus Moller, Eschweiler (DE)

Correspondence Address: Joseph W. Berenato, III, Liniak, Berenato & White, LLC, Suite 240, 6550 Rock Spring Drive, Bethesda, MD, 20817, US

(21) Appl. No.: 10/721,826

(22) Filed: Nov. 26, 2003

(30) Foreign Application Priority Data
Nov. 28, 2002 (DE) 202 18 503.6

(51) Int. Cl. C12Q 1/68; C12M 1/34

(52) U.S. Cl. 435/6; 435/287.2; 210/656

(57) ABSTRACT

The invention concerns a separation device (1) for processing biomolecules, especially for isolating nucleic acids, with a separation column (2) that has a top side inlet (7) and a bottom side outlet (8) and in which a separation material (10) is arranged, as well as with a collection vessel (3) for collecting the liquid exiting from the outlet (8), wherein the separation column (2) is inserted into the collection vessel (3) and is closed off with a removable cover (4), wherein the interiors of the collection vessel (3) and the separation column (2) have a pressure-equalizing connection (11, 12) in addition to the outlet (8) from the separation column (2).

### CROSS-RFERENCE TO RELATED APPLICATIONS

Applicants hereby claim priority pursuant to 35 U.S.C. § 119 to utility model application number 202 18 503.6, filed Nov. 28, 2002 in the Federal Republic of Germany, the disclosure of which is incorporated herein by reference.

### FIELD OF THE INVENTION

The invention concerns a separation device for processing biomolecules, especially for isolating nucleic acids, with a separation column that has a top side inlet and a bottom side outlet and in which a separation material is arranged, as well as with a collection vessel for collecting the liquid exiting from the outlet, wherein the separation column is inserted into the collection vessel and is closed off with a removable cover.

### BACKGROUND OF THE INVENTION

To obtain diagnostic information on pathogens that may be present in the body, or on the particular genetic predisposition of a person, it has proven advantageous to isolate nucleic acids or proteins in pure form from his/her body fluids. State-of-the-art separation devices such as are known, for example, on the basis of DE 38 43 610 A1, WO 95/18851 and EP 0 940 676 A2 are used for this purpose. Such separation devices have a separation column with a top side inlet for pouring in fluid and a bottom side outlet. Separation material is fixed into position in the separation column, for example in the form of a membrane comprised of organic or inorganic materials. The separation column is inserted into a collection vessel.

This type of separation device is designed for use in a centrifuge. The centrifuge serves to bring about or promote and to accelerate the flow of the liquid poured via the inlet into the separation column through the separation material. The nucleic acid is bound to the separation material, for example, a silica membrane, when it flows through. The impurities are washed out in a second step, and the nucleic acid purified in this manner is eluted in a third step. For details on the process, please refer to the description in EP 0 940 676.

When such separation devices are used there exists a considerable risk of contamination to the environment and therewith an increased risk of infection for those processing the bodily fluids, especially when blood products are involved. For this reason the separation column is sealed as liquid-tight as possible with a cover after the respective liquid is poured in, before being placed in the centrifuge. The cover may also extend over the collection vessel and be screwed onto the collection vessel (cf. EP 0 940 676 A2).

In order to prevent the creation of vacuum conditions in the separation column and the build-up of excess pressure in the collection vessel during the transfer of liquids from the separation column into the collection vessel, the separation column and/or the collection vessel are constructed in the upper region such that the interior of the collection vessel has a connection to the outside atmosphere, for example through ventilation slots present there. Without such an equalization of pressure, a sudden pressure equalization would occur after the end of the liquid transfer through a flow of air in the opposite direction through the layer of separation material. This layer would be destroyed as a result of the forces arising in this connection. The purification could not be successfully completed, and the sample would be lost.

### SUMMARY OF THE INVENTION

It has now been determined that the centrifuge is contaminated with bodily fluid residues despite the sealing of the separation column with the cover. These residues are diffused into the laboratory environment as an aerosol through the air slots of the centrifuge as a result of the centrifugal motion, and lead to contamination of the environment and therewith to a high risk of infection. Only following extensive studies did it come to be recognized that residues of bodily fluids continue to adhere to the interior walls of the collection vessel after the separation process and the emptying of the collection vessel, and that these residues are forced toward the outside following reassembly of the separation column and the collection vessel for the purpose of cleansing using a washing buffer, as a result of the excess pressure generated in the second centrifugation step in the lower part of the collection vessel through the ventilation slots, consequently contaminating the interior of the centrifuge.

The invention is consequently based on the objective of constructing a separation device of the type mentioned at the beginning such that a destruction of the separation material following the conclusion of the liquid transfer is avoided, while contamination of the environment by liquid expelled from the collection vessel is reliably suppressed.

This objective is accomplished in accordance with the invention in that the interiors of the collection vessel and the separation column have a pressure-equalizing connection in addition to the outlet of the separation column. The basic idea of the invention is thus to avoid the aforementioned problem by an internal pressure equalization, which is already operative during the liquid transfer, and in this way to prevent residues of bodily fluids still adhering to the interior walls of the collection vessel from being expelled from the latter and reaching the environment. For this reason, there no longer exists a risk of contamination and therewith of infection.

It is provided in the construction of the invention that the collection vessel and the separation column are sealed or can be sealed air- and/or liquid-tight by means of the cover. Such a sealing is possible as a result of internal pressure equalization, for in this way the formation of a differential pressure between the interiors of the separation column and the collection vessel is prevented, thus avoiding the risk of a sudden pressure equalization following termination of the liquid transfer through the separation material that would destroy the separation material or leave the liquid transfer incomplete. The separation device constructed in this manner is hermetically sealed during use of the centrifuge so that an exit of infection-threatening liquids cannot occur under any conditions.

In a further refinement of the invention it is provided that the cover can be screwed onto or is screwed onto the collection vessel in an inherently known manner (cf. EP 0 940 676). The cover is designed to be hat-like for this purpose, and is screwed onto the exterior of the collection vessel via a thread. But it can also be slipped on and held fast by means of latching flanges. It is also appropriate for the separation column to have an edge flange that is pressed by means of the cover onto the collection vessel, forming a seal. The edge flange is advantageously tip-stretched onto the inlet of the separation column and then lies on the upper edge of the collection vessel. Then it is possible for the edge flange to be clamped between the cover and the collection vessel.

The pressure-equalizing connection is advantageously constructed as an opening in the upper region of the separation column so that the admissible liquid level in the separation column after filling is not essentially restricted. A pressure-equalization channel between the separation column and the collection vessel should be part of the pressure-equalization connection, and may also have a connection to the passage opening. The pressure-equalization channel can have a vertical groove in the interior of the collection vessel and/or the exterior of the separation column. Providing an annular slot between the two that is large enough to enable a continuous pressure equalization is also appropriate, however.

Finally, it is provided according to the invention that the volume enclosed by the collection vessel beneath the lower end of the outlet of the separation column is at least 1.5 times, preferably twice as large, as the free volume of the separation column beneath the entry of the pressure-equalizing connection into the interior of the separation column. Due to this volumetric proportion, wetting the outlet and/or the underside of the separation column with the fluid exiting the collection vessel, leading to a contamination when the separation column is removed from the collection vessel, is avoided.

### DESCRIPTION OF THE DRAWING FIGURE

FIG. 1 is a cross-sectional view of a separation device according to the invention.

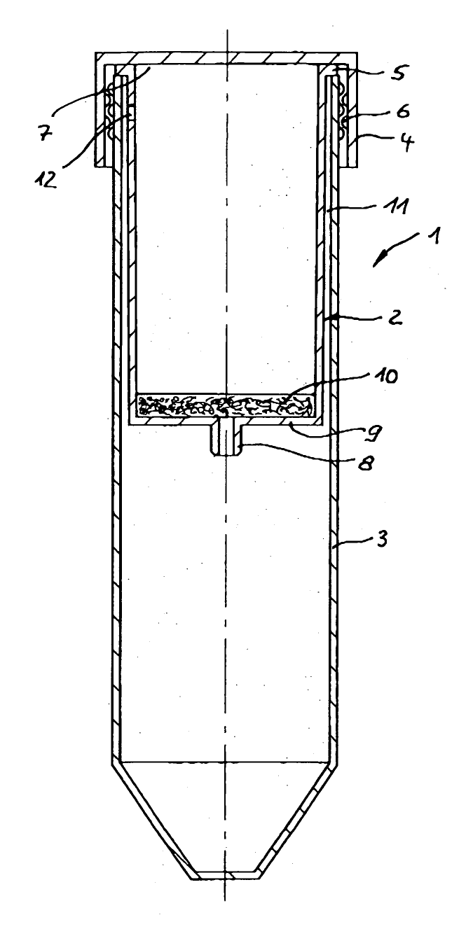

### DETAILED DESCRIPTION OF THE PREFERRED EMBODIMENT

The invention is illustrated in greater detail on the basis of an exemplary embodiment in the drawing. It depicts in vertical section a separation device 1 for processing biomolecules. The separation device 1 is constructed in three parts. It consists of a cylindrical separation column 2, a likewise cylindrical collection vessel 3, and a hat-like cover 4.

The separation column 2 is almost completely inserted telescope-like into the collection vessel 3. On its upper edge it has an edge flange 5 that projects outwardly and lies on the upper face of the collection vessel 3. The cover 4 extends over both the separation column 2 and the collection vessel 3 and is screwed onto the exterior of the collection vessel 3 by means of a thread 6. Moreover, in this situation the edge flange 5 is clamped at all times between the interior of the cover 4 and the upper face of the collection vessel 3, forming a seal.

The separation column 2 has an inlet 7 on its upper side and a nozzle-like outlet 8 on its underside. The separation column 2 has an annular shoulder 9 in the area of the outlet 8, on which a silica membrane 10 lies and is supported.

The cylindrical exterior of the separation column 2 and the interior of the collection vessel 3 are distanced from one another such that an annular slot 11 exists between them. It is guaranteed by the distance projections (which are not represented here in greater detail) that the annular groove 11 has the same width over its entire periphery. In the upper region, the separation column 2 has a passage opening 12, which, with the annular groove 11, produces a pressure-equalizing connection between the interior of the separation column 2 and the lower region of the interior of the collection vessel 3. In this way, the occurrence of pressure differences between the two interiors is avoided especially in the centrifuge.

The cover 4 is removed to isolate nucleic acids from a bodily fluid such as blood, the bodily fluid is pipetted through the inlet 7 into the separation column 2, and then the cover 4 is screwed on again. Then the separation device 1 as a whole is then inserted into a centrifuge such that a centrifugal force directed longitudinally toward the bottom of the collection vessel 3 acts on the separation device 1. The transfer of the liquid sample through the silica membrane 10 is brought about in this way. Moreover the nucleic acid is bound on the silica membrane 10. The liquid then enters the interior of the collection vessel 3 through the outlet 8 and accumulates there on the bottom. During this process, a pressure equalization between the interiors of the separation column 2 and the collection vessel 3 continuously takes place via the annular slot 11 and the passage opening 12 so that a sudden pressure equalization will not take place through the outlet 8 once the liquid transfer has ended.

Following the first centrifugation step, the cover 4 is opened again. It is now possible to remove the separation column 2 and empty the collection vessel 3. This can be dispensed with as long as there is still sufficient space between the liquid level in the collection vessel 3 and the outlet 8 of the separation column 2. A washing buffer is then poured into the separation column 2 and the separation device 1 is closed again by replacing the cover 4. The separation device 1 is then subjected to a further centrifugation step in which the washing buffer is forced through the silica membrane 10 taking the impurities with it. Once again, an internal pressure equalization occurs between the interior spaces of the separation column 2 and the collection vessel 3 with the consequence that no excess pressure is created in the collection vessel which could destroy the silica membrane 10 after conclusion of the liquid transfer or which could reach into the atmosphere if the cover 4 is not tight.

Following the conclusion of the washing process (it can take place in several steps), the cover 4 is removed, the separation column 2 is removed from the collection vessel 3 and the collection vessel 3 is emptied. The collection vessel 3 is then either cleansed or replaced by a new collection vessel. The separation column 2 is then reinserted into the collection vessel 3. An elution buffer is poured into the separation column 2, and, after being sealed with the cover 4, the separation device 1 is subjected to a new centrifugation step. Here the nucleic acid is eluted out of the silica membrane 10 and collected in the collection vessel 3. It then is available for further analyses.

What we claim is:

1. Separation device (1) for processing biomolecules, especially for isolating nucleic acids, with a separation column (2) that has a top side inlet (7) and a bottom side outlet (8) and in which a separation material (10) is arranged, as well as with a collection vessel (3) for collecting the liquid exiting from the outlet (8), wherein the separation column (2) is inserted into the collection vessel (3) and is closed off with a removable cover (4), wherein the interior of the collection vessel (3) and the separation column (2) have a pressure-equalizing connection (11, 12) in addition to the outlet (8) from the separation column (2).

2. Separation column according to claim 1, wherein the collection vessel (3) and the separation column (2) are closed or can be closed air- and or liquid-tight by means of the cover (4).

3. Separation device according to claim 1, wherein the cover (4) is or can be screwed on or positioned on the collection vessel (3).

4. Separation device according to claim 3, wherein the cover (4) is designed to be hat-like and is or can be screwed (6) onto the exterior of the collection vessel (3).

5. Separation device according to one of claim 1, wherein the separation column (2) has an edge flange (5) that is pressed onto the collection vessel (3) by means of the cover (4), forming a seal.

6. Separation device according to claim 5, wherein the edge flange (5) is tip-stretched onto the inlet (7).

7. Separation device according to claim 6, wherein the edge flange (5) lies on the upper edge of the collection vessel (3).

8. Separation device according to claim 5, wherein the edge flange (5) is clamped between the cover (4) and the collection vessel (3).

9. Separation device according to claim 1, wherein the pressure-equalizing connection has a port (12) in the upper region of the separation column (2).

10. Separation device according to claim 1, wherein a pressure-equalizing channel (11) between the separation column (2) and the collection vessel (3) is part of the pressure-equalizing connection.

11. Separation device according to claim 10, wherein the pressure-equalizing channel (10) is constructed as an annular slot (11).

12. Separation device according to claim 1, wherein the volume enclosed by the collection vessel (3) beneath the lower end of the outlet (8) of the separation column (2) is at least 1.5 times as large as the free volume of the separation column (2) beneath the inlet of the pressure-equalizing connection (11, 12) in the interior of the separation column (2).
